(19) United States
(12) Patent Application Publication
(10) Pub. No.: US 2009/0047504 A1
(43) Pub. Date: Feb. 19, 2009

(54) PROTECTIVE PANEL, METHOD FOR MAKING THE SAME, AND DISPLAY DEVICE EMPLOYING THE SAME

(75) Inventors: ZI-LI WU, Shenzhen (CN); JAMES JUEHUI HONG, Shenzhen (CN); LONE-WEN TAI, Tu-Cheng (TW); JUN DAI, Shenzhen (CN); AI-JUN XU, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/960,744

(22) Filed: Dec. 20, 2007

(30) Foreign Application Priority Data
Aug. 13, 2007 (CN) 200710201350.4

(51) Int. Cl. B05D 5/06; B32B 5/16

(52) U.S. Cl. 428/331; 428/421; 428/336; 427/162

(57) ABSTRACT

The present invention discloses a protective panel, method for making the same, and display device employing the same. The protective panel includes transparent base plate and an anti-reflective film formed on a side surface of the transparent base plate. The anti-reflective film is made of a composite material consisting of polytetrafluoroethylene resin and silicon dioxide particles.

### BACKGROUND OF THE INVENTION

1. Field of the Invention

The present invention relates a protective panel, a method for making the same, and a display device employing the same.

2. Discussion of the Related Art

Nowadays, liquid crystal display panels, plasma display panels and so on are good candidates for use in various display devices because of their light weight and small size. Generally, the display panels are easily scratched and damaged if there are no mechanisms to protect them. In order to protect a display panel, the display panel and other electronic components are usually positioned in a chamber of a housing, and a protective panel seals the chamber to protect the display panel. The protective panel is often made of transparent plastic plate or glass plate. As a result, when light exits the panel and reaches the protective panel, light entering the protective panel at certain angles of incidence is reflected off of the surface of the protective panel. Thus, an intensity of light after passing through the protective panel is decreased, resulting in poor display effect of the display device.

In order to solve the above problem, an anti-reflective film is deposited on the surface of the protective panel to decrease light reflection. Typically, the anti-reflective film is formed by a vacuum deposition methodology, such as thermal evaporation, sputtering, and other methods. A material of the anti-reflective film is often selected from one of a group consisting of magnesium fluoride (MgF₂) and silicon dioxide (SiO₂). However, the refractive index of MgF₂ is 1.38 and the refractive index of SiO₂ is 1.45. Due to the greater refractive index of MgF₂ and SiO₂ over glass or plastic, the anti-reflective property of the protective panel is limited.

Therefore, a new protective panel and a display device employing the same is desired in order to overcome the above-described shortcomings. A method for making the protective panel is also desired.

### SUMMARY

A protective panel according to a preferred embodiment includes a transparent base plate and an anti-reflective film formed on one surface of the transparent base plate. The anti-reflective film is made of a composite material consisting of polytetrafluoroethylene resin and silicon dioxide particles.

A display device according to a preferred embodiment includes a display panel and a protective panel as described in the previous paragraph positioned on a side of the display panel.

A method for making a protective panel includes: blending a predetermined amount of tetrahydrofuran and Isopropylalcohol to yield a solvent; adding a predetermined amount of methacryloxypropyltrimethoxysilane, methyl methacrylate, methyl-perfluorooctane sulfonate-amino-ethyl acrylate, and polytetrafluoroethylene resin to the solvent, and then nitrogen gas is introduced to protect the solvent; adding a predetermined amount of 2-methylpropionitrile to the solvent, and then the solvent is under reflux reaction to yield a polymer solution; adding tetraethyl orthosilicate, ammonia, isopropylalcohol, and deionized water solution to the polymer solution at a predetermined temperature, and stirring the polymer solution; the polymer solution stands at room temperature for a relative long time to yield a first sol; adding tetraethyl orthosilicate, hydrochloric acid, and Isopropylalcohol into a deionized water solution, and mixing; the deionized water solution stands at room temperature to yield a second sol; adding the second sol to the first sol at room temperature; a mixture of the first sol and the second sol is stirred and under reflux reaction to yield a compound sol consisting of polytetrafluoroethylene resin and silicon dioxide particles; coating the compound sol on one surface of a base plate to form a thin film; and solidifying the thin film to form an anti-reflective film.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present protective panel, and display device employing the same. Moreover, in the drawings, like reference numerals designate corresponding parts throughout several views, and all the views are schematic.

FIG. 1 is an exploded view of a display device incorporating a protective panel in accordance with a preferred embodiment of the present invention.

FIG. 2 is an isometric view of the protective panel of FIG. 1.

FIG. 3 is a side cross-sectional view taken along line III-III of FIG. 2.

FIG. 4 shows a light path of an incident light entering the protective panel of FIG. 2.

### DETAILED DESCRIPTION OF THE EMBODIMENTS

Reference will now be made to the drawings to describe preferred embodiment of the present protective panel, and display device employing the same, in details.

The present protective panel can be adopted by displays of any electronic devices such as computers, mobile phones, personal digital assistants, monitors, and so on. In a preferred embodiment, a display device of a mobile phone is taken here as an exemplary to describe.

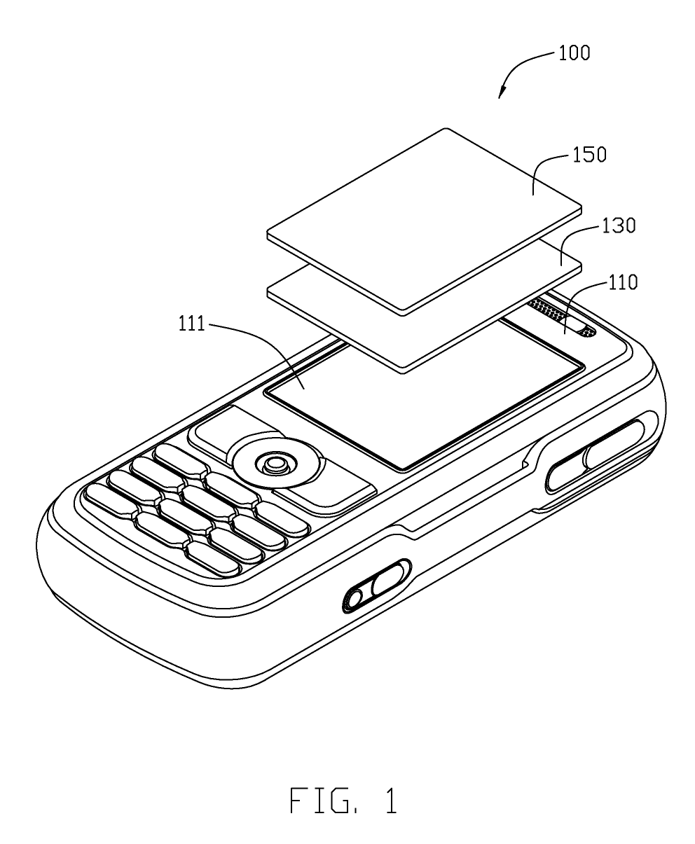

Referring to FIG. 1, a display device 100 includes a main body 110, a liquid crystal display panel 130, and a protective panel 150. The main body 110 defines a rectangular opening 111 configured as a display window. The liquid crystal display panel 130 is positioned in the main body 110 with a surface facing (exposed) to the rectangular opening 111. The protective panel 150 seals the opening 111, thus protecting the liquid crystal display panel 130.

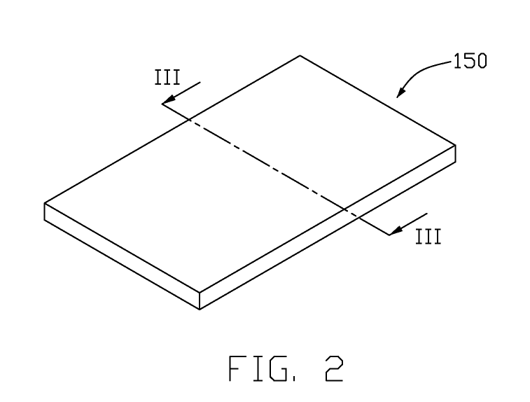

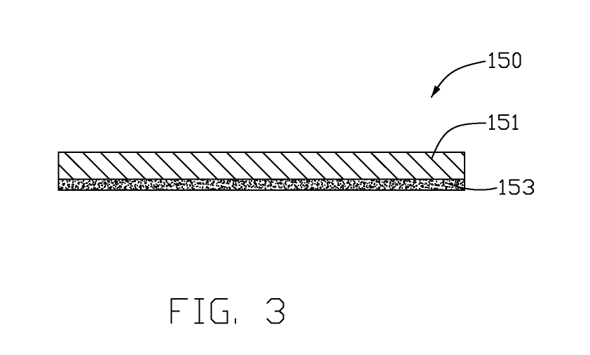

Referring to FIGS. 2 and 3, the protective panel 150 includes a base plate 151 and an anti-reflective film 153 formed on a surface of the transparent base plate 151. The anti-reflective film 153 is made of a composite material consisting of polytetrafluoroethylene (PTFE) resin and SiO₂ particles dispersed in the PTFE resin. In the illustrated embodiment, a diameter of each SiO₂ particle is less than 300 nanometers.

A thickness of the anti-reflective film 153 satisfies the following expression: d=(2k+1)λ₀/4n₁, where d represents a thickness of the anti-reflective film 153, k represents a natural number, such as 0,1,2,3. . . , λ₀ represents a wavelength of light, and n₁ represents the refractive index of the anti-reflective film 153. When light travels through a substance, the longer (time or distance) light travels in the substance the more light is absorbed (lost) by the substance. Thus the thickness of the anti-reflective film 153 is preferred to be as small as possible. In the illustrated embodiment, the thickness of the anti-reflective film 153 is configured to be in a range from about 110 nanometers to about 120 nanometers.

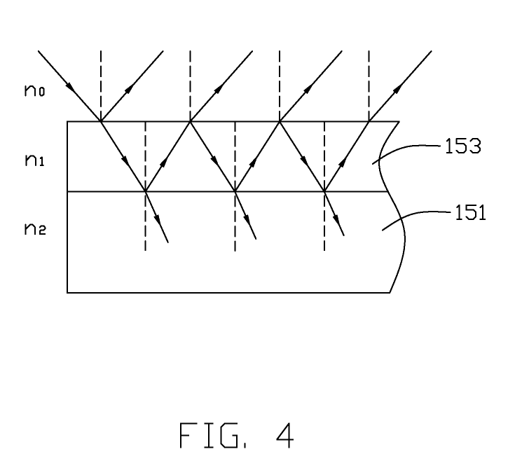

Since the refractive index of the anti-reflective film 153 is in the range from 1.18 to 1.23, referring to FIG. 4, the anti-reflective effect of the anti-reflective film 153 is at best when the thickness satisfies the following expression n₁=(n₂*n₀)^{1/2} according to the Fresnel formula and laws of refraction. In the above expression, n₀, n₁, n₂ respectively represent the refractive indexes of air, the anti-reflective film 153, and the base plate 151. In the illustrated embodiment, the refractive index of the base plate 151 is in a range from 1.4 to 1.8, thus, the square root of the refractive index of base plate 151 is in a range from 1.18 to 1.34. Since the square root of the refractive index of base plate 151 is close to the refractive index of the anti-reflective film 153, the anti-reflective film 153 has a relatively high anti-reflective property. For example, when light enters the anti-reflective film 153, only 4% to 5% of the light is reflected away, in other words, more than 94.5% of the light passes through the protective panel 150.

In the display device 100 employing the protective panel 150, the protective panel 150 has a relative high anti-reflective effect, thus, an amount of the light that passes through the protective panel 150 is increased. As a result, the display employing the protective panel 150 has a nice display effect

The anti-reflective film 153 can be configured to be a single layer due to that the anti-reflective film 153 has relatively high anti-reflective property. In a dual-layered or multi-layered anti-reflective film, a thickness of each layer and a total thickness of the two-layered or multi-layered anti-reflective film both need to be controlled precisely. By comparison, the anti-reflective film 153 is easy to be manufactured because only the thickness of the anti-reflective film 153 needs to be controlled precisely.

In addition, the anti-reflective film 153 is positioned on an inner surface of the base plate 151 facing the liquid crystal display panel 130. Therefore, the anti-reflective film 153 cannot be scratched and/or damaged from outside the display device 100. Furthermore, the protective panel 150 has a relative high hardness even without a hard coating deposited on the base plate 151 because the material of the base plate 151 is glass. Thus, when manufacturing the protective panel 150, a process of depositing a hard film on the protective panel 150 is not needed.

It can be understood that the liquid crystal display panel 130 can be replaced by other display panel such as plasma display, and so on. The materials of the base plate 151 can be replaced by transparent materials, such as plastic, and so on.

A method for making the above protective panel 150 is provided in details below;

A predetermined amount of tetrahydrofuran and Isopropylalcohol are blended together to yield a solvent.

A predetermined amount of methacryloxypropyltrimethoxysilane, methyl methacrylate, MPSAEA (methyl-perfluorooctane sulfonate-amino-ethyl acrylate), and PTFE are added to the solvent. Then nitrogen gas is introduced to protect the solvent.

A predetermined amount of 2-methylpropionitrile is added to the solvent. Then the solvent is under reflux reaction for a predetermined time, such as 8 hours, thereby yielding a polymer solution.

A predetermined amount of tetraethyl orthosilicate, ammonia, isopropylalcohol, and deionized water are added to the polymer solution at a predetermined temperature, and the polymer solution is stirred.

The polymer solution stands at room temperature for a relative long time to form a first sol.

A predetermined amount of tetraethyl orthosilicate, hydrochloric acid, and Isopropylalcohol are added into a deionized water solution, and mixed.

The deionized water solution stands at room temperature to yield a second sol.

The second sol is added to the first sol at room temperature.

A mixture of the first sol and the second sol is stirred and under reflux reaction with a predetermined time, such as 8 hours, to yield a compound sol consisting of PTFE resin and SiO₂ particles.

A thin film is formed on a surface of the base plate by applying the compound sol on the surface by rotating coating method.

The thin film is dried in air for a about 1 hours, after that, cured at about 80° C. for about 0.5 hours to form the above mentioned anti-reflective film 153.

It can be understood that, the first sol and the second sol can be formed in a reversed order or at a same time. Rotating coating can be replaced by dipping coating or spray coating. In addition, cleaning workroom and a relative humility of 50% of the workroom is required in manufacturing process.

It can be understood that, any plastic or glass materials can be used as the material of the base. It should be noted that, plastic base plate may melt (deform) when evaporating deposition process or sputtering deposition process is performed on the plastic base plate due to a high temperature of the process, but would not bent in coating process because the temperature of the coating process can be relative low by extending a curing time. Comparing to the evaporating deposition device and sputtering deposition device, the device of the coating has relative low cost.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A protective panel comprising:
a transparent base plate; and
an anti-reflective film formed on one surface of the transparent base plate, wherein the anti-reflective film is made of a composite material consisting of polytetrafluoroethylene resin and silicon dioxide particles.

2. The protective panel as claimed in claim 1, wherein a thickness of the anti-reflective film is in a range from about 110 nanometers to about 120 nanometers.

3. The protective panel as claimed in claim 1, wherein a reflection index of the anti-reflective film is in a range from 1.18 to 1.23.

4. The protective panel as claimed in claim 1, wherein a diameter of each silicon dioxide particle is less than 300 nanometers.

5. The protective panel as claimed in claim 1, wherein a reflection index of the transparent base plate is in range from 1.4 to 1.8.

6. The protective panel as claimed in claim 1, wherein a material of the transparent base plate is one of plastic and glass.

7. A display device, comprising:
a display panel; and
a protective panel disposed on a side of the display panel, the protective panel comprising:
a transparent base plate; and
an anti-reflective film formed on one surface of the transparent base plate, wherein the anti-reflective film is made of a composite material consisting of polytetrafluoroethylene resin and silicon dioxide particles.

8. The display device as claimed in claim 7, wherein the anti-reflective film is on the surface, of the transparent base plate, which is opposite to the surface facing the display panel.

9. The display device as claimed in claim 7, wherein a thickness of the anti-reflective film is in a range from about 110 nanometers to about 120 nanometers.

10. The display device as claimed in claim 7, wherein a reflection index of the anti-reflective film is in a range from 1.18 to 1.23.

11. The display device as claimed in claim 7, wherein a diameter of each silicon dioxide particle is less than 300 nanometers.

12. The display device as claimed in claim 7, wherein a reflection index of the transparent base plate is in range from 1.4 to 1.8.

13. The display device as claimed in claim 7, wherein a material of the transparent base plate is one of the plastic and glass.

14. A method for making a protective panel, comprising:
blending a predetermined amount of tetrahydrofuran and Isopropylalcohol to yield a solvent;
adding a predetermined amount of methacryloxypropyltrimethoxysilane, methyl methacrylate, methyl-perfluorooctane sulfonate-amino-ethyl acrylate, and polytetrafluoroethylene resin to the solvent and introducing nitrogen gas to protect the solvent;
adding predetermined amount of 2-methylpropionitrile to the solvent, and then the solvent is under reflux reaction to yield a polymer solution;
adding tetraethyl orthosilicate, ammonia, isopropylalcohol, and deionized water solution to the polymer solution at a predetermined temperature, and stirring the polymer solution;
the polymer solution stands at room temperature to yield a first sol;
adding tetraethyl orthosilicate, hydrochloric acid, and Isopropylalcohol into a deionized water solution, and mixing;
the deionized water solution stands at room temperature to yield a second sol;
adding the second sol to the first sol at room temperature;
a mixture of the first sol and the second sol is stirred and under reflux reaction to yield a compound sol consisting of polytetrafluoroethylene resin and silicon dioxide particles;
coating the compound sol on one surface of a base plate to form a thin film; and
solidifying the thin film to form an anti-reflective film.

15. The method as claimed in claim 14, wherein the coating method is selected one of rotating coating, dipping coating, and spraying coating.
